(19) United States
(12) Patent Application Publication
(10) Pub. No.: US 2008/0198266 A1
(43) Pub. Date: Aug. 21, 2008

(54) VIDEO OUTPUT DEVICE, VIDEO OUTPUT METHOD, VIDEO OUTPUT PROGRAM, VIDEO PROCESSING SYSTEM, VIDEO PROCESSING DEVICE, VIDEO PROCESSING METHOD, AND VIDEO PROCESSING PROGRAM

(75) Inventor: Haruhisa KURANE, Shiojiri (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 12/033,041

(22) Filed: Feb. 19, 2008

(30) Foreign Application Priority Data
Feb. 20, 2007 (JP) 2007-038919
Dec. 26, 2007 (JP) 2007-333903

(51) Int. Cl. H04N 9/77

(52) U.S. Cl. 348/557

(57) ABSTRACT

A video output device which converts image data into a YUV system video signal composed of a brightness signal Y and a chrominance signal UV and outputs the video signal obtained by the conversion through a predetermined interface is disclosed. The video output device includes: a mantissa part converting unit which, with respect to first image data composed of pixel data in which a pixel value is expressed by a floating point format in which a mantissa part has N bits (N is a natural number of 2 or more), a cardinal number is X (X is a natural number of 2 or more) and an exponential part has M bits (M is a natural number of 2 or more), converts mantissa part data of the pixel data configuring the first image data into the YUV system video signal; a multiplexing unit which multiplexes exponential part data of the pixel data configuring the first image data to the chrominance signal UV of the YUV system video signal; and a video signal output unit which outputs the YUV system video signal including the brightness signal Y and the chrominance signal UV obtained by multiplexing the exponential part data.

### BACKGROUND

1. Technical Field

The present invention relates to a device for converting image data into a YUV system video signal and outputting the YUV system video signal, and more particularly to a video output device, a video output method, a video output program, a video processing system, a video processing device, a video processing method and a video processing program, which are adapted for converting image data of a floating point format into a YUV system video signal and outputting the YUV system video signal.

2. Related Art

In order to compensate for a narrow dynamic range (hereinafter, referred to as a D range) of an image pickup device, an image pickup device capable of picking up an image at two or more types of exposure times in one frame period was suggested. In an image pickup device configuring one frame using two fields, a method of picking up an image by changing the exposure time in an odd-numbered or even-numbered field was suggested.

That is, image data obtained by picking up an image at two types or more of exposure times (for example, a standard exposure time T1 and a short exposure time T2 (T1>T2) is synthesized by the outside or the inside of a sensor so as to obtain image data having an extended D range. Image data having a relatively wide D range is generally called high dynamic range (HDR) image data.

Technologies about extension of the D range of the pickup image data include, for example, an image pickup device described in JP-A-5-22670.

The image pickup device of JP-A-5-22670 reads stored charges at different exposure times several times and replaces pixel data saturated in a longer exposure time in pixel data configured by charges read at the different exposure times with pixel data which is not saturated in a shorter exposure time, thereby obtaining image data having a wide D range.

The image data having the wide dynamic range obtained by the image pickup device of JP-A-5-22670 is data of a fixed point format and is mainly output after the amount of information is reduced according to the capability of an output device. For example, when the amount of information is reduced, the D range becomes about 50 dB.

Meanwhile, a problem such as overexposure or underexposure due to a narrow D range causes lack of pixel information and thus may be problematic when an objective operation is performed in the system. In particular, in a machine vision, it cannot be determined whether overexposure is an image or a defect and thus overexposure is fatal. In the machine vision, since the image is globally (macro) grasped in area detection (labeling), edge detection, correlation detection, binarization process, the system capability such as recognition is influenced by the information loss such as overexposure or underexposure, rather than arithmetic operation errors of the pixel value.

In order to solve this problem, a video processing system for transmitting/receiving a HDR video is attracting attention.

As a HDR image format, a format called Radiance for expressing a pixel value by a floating point. The Radiance format expresses an exponential part E (8 bits) as well as pixels RGB (each 8 bits) by the floating point format of 32 bits per pixel. If the pixel value is expressed by the Radiance format (Ri, Gi, Bi, E), the actual brightness value of each color is expressed by the floating point format of Equation 1.

R=Ri×2^{(E-128)}

G=Gi×2^{(E-128)}

B=Bi×2^{(E-128)} Equation 1

Next, an output format of a video signal between a video signal source such as an electronic camera which is a video output side and a video processing/displaying device (hereinafter, referred to as a video processing device) which is a video receiving side will be described.

In a color image, the output of the video signal source is output to the video processing device with a format of a RGB signal or a YUV signal (brightness signal and chrominance signal). The YUV signal is standardized in ITU-R BT.601 in the International Telecommunication Union (ITU). This standard is used in an NTSC or a JPEG so as to reduce the amount of information in a range which is not recognized by the eyes of a human, in consideration of the visual characteristics of the eyes of the human. The YUV system capable of reducing the amount of information is employed in order to efficiently use a restricted frequency band in the NTSC or reduce a file size in the JPEG.

The YUV system is composed of a Y signal indicating the brightness signal and a U signal and V signal (collectively referred to as a UV signal) indicating the chrominance signal. The Y signal of the total pixel number forming an image is output to the video processing device. In contrast, in the UV signal, the amount of output information is reduced (thinned) using low spatial resolution for the color of the eyes of the human. For example, in the U signal and the V signal of YUV411 format, the amount of output information is reduced to ¼, compared with the case where the U signal and the V signal of the total pixel number forming the image are output.

An interface between the video signal source and the video processing device will be described. For example, the YUV411 format is used in the output of the video data between the video signal source, such as the electronic camera, and the video processing device in order to improve the output efficiency due to the reduction of the amount of video information.

At this time, for example, in the case where the video signal source outputs the video signal to the video processing device through a predetermined interface at a frame rate of 30 fps (frame/sec), for example, as shown in FIG. 13A, high-speed data transmission is realized using three ports including an 8-bit port for outputting the Y signal, an 8-bit port for outputting the chrominance signal U and V, and a synchronization signal port for establishing synchronization between the video signal source and the video processing device. As shown in FIG. 13B, the output of the YUV system video signal may be realized using two ports including an 8-bit port for transmitting the Y signal and the UV signal and the synchronization signal port.

In FIG. 13A, the synchronization signal port outputs three signals including a vertical synchronization signal indicating the start of a frame, a horizontal synchronization signal indicating the start of a line, and a pixel synchronization signal for synchronization of a pixel or a decoded synchronization signal obtained by multiplexing the three signals. The port for the Y signal outputs overall image data and thus output the data in synchronization with the pixel synchronization signal. In contrast, since the UV signal is thinned, the port for the UV signal multiplexes the chrominance signal U and V and outputs the multiplexed the chrominance signal (the U signal and the V signal are alternately output). Since the UV signal is not output in an even-numbered line by the partial removal, dummy data is output.

However, in this technology, for example, in the image pickup device of JP-A-5-22670, when the image data having the wide D range is output to the video processing device as the data of the floating point format and the YUV system, a port for outputting a data signal of an exponential part needs to be provided independent of the port for the Y signal and the port for the UV signal.

### SUMMARY

An advantage of some aspects of the invention is that it provides a video output device, a video output method, a video output program, a video processing system, a video processing device, a video processing method and a video processing program, which are adapted for converting image data of a floating point format into a YUV system video signal and outputting the YUV system video signal using the existing interface.

According to a first aspect of the invention, there is provided a video output device which converts image data into a YUV system video signal composed of a brightness signal Y and a chrominance signal UV and outputs the video signal obtained by the conversion through a predetermined interface, the video output device including: a mantissa part converting unit which, with respect to first image data composed of pixel data in which a pixel value is expressed by a floating point format in which a mantissa part has N bits (N is a natural number of 2 or more), a cardinal number is X (X is a natural number of 2 or more) and an exponential part has M bits (M is a natural number of 2 or more), converts mantissa part data of the pixel data configuring the first image data into the YUV system video signal; a multiplexing unit which multiplexes exponential part data of the pixel data configuring the first image data to the chrominance signal UV of the YUV system video signal; and a video signal output unit which outputs the YUV system video signal including the brightness signal Y and the chrominance signal UV obtained by multiplexing the exponential part data.

By this configuration, with respect to image data composed of pixel data in which a pixel value is expressed by a floating point format in which a mantissa part has N bits (N is a natural number of 2 or more), a cardinal number is X (X is a natural number of 2 or more) and an exponential part has M bits (M is a natural number of 2 or more), mantissa part data of the pixel data configuring the image data can be converted into the YUV system video signal by the mantissa part converting unit, exponential part data of the pixel data configuring the image data can be multiplexed to the chrominance signal UV of the YUV system video signal by the multiplexing unit, and the YUV system video signal including the brightness signal Y and the chrominance signal UV obtained by multiplexing the exponential part data can be output by the video signal output unit.

Accordingly, since the exponential part data of the pixel data of the floating point format can be multiplexed to the chrominance signal UV and can be output, the video signal including the exponential part data can be output using the YUV system existing interface, without separately providing an interface (port) for outputting the exponential part data.

Since the image data of the floating point format can be treated, the HDR image data of the floating point format can be simply output using the existing interface. That is, the HDR image data having a sufficient contrast ratio and dynamic range can be simply output without generating overexposure or underexposure. For example, in the HDR image data of the floating point format having an 8-bit mantissa part and a 4-bit exponential part, it is possible to express a dynamic range of about 32000 times (90 dB), compared with HDR image data expressed by an 8-bit integer value.

In the video output device according to a second aspect of the invention, the video output device further includes an exponential part converting unit which converts the M-bit exponential part of the pixel data configuring the first image data into an m-bit (m is a natural number of M>m) exponential part; and a packing exponential part data generating unit which generates packing exponential part data configured by the exponential part data in the pixel data of a predetermined number of pixels for each pixel data of the predetermined number of successive pixels in a predetermined scan direction, in second image data which is image data after converting the exponential part by the exponential part converting unit, the mantissa part converting unit converts the mantissa part data of the pixel data configuring the second image data into the YUV system video signal, and the multiplexing unit multiplexes the packing exponential part data to the chrominance signal UV of the YUV system video signal.

By this configuration, the data amount of the mantissa part of the pixel data of the floating point format is reduced and thus the data output amount can be reduced.

By converting the exponential part data to the bit number which is susceptible to be treated by the YUV system, it is possible to multiplex the exponential part data of the image data of the floating point format to the chrominance signal UV.

In the video output device according to a third aspect of the invention, the first image data is color image data of a RGB (red, green and blue) format, the value of each of the color elements of R, G and B configuring the pixel value is expressed by the floating point format in which the mantissa part has the N bits, the cardinal number is 2 and the exponential part has the M bits, and the value expressed by the M-bit exponential part is composed of pixel data having the same value in the color elements, the exponential part converting unit converts the M-bit exponential part corresponding to the color elements of the pixel data configuring the first image data into 4-bit or less exponential part having the same value in the color elements, the mantissa part converting unit converts the mantissa part data corresponding to the color elements of the pixel data configuring the second image data into a YUV411 system video signal which is one of the YUV system, and the packing exponential part data generating unit generates the packing exponential part data composed of the exponential part data in the pixel data of four pixels for each pixel data of successive four pixels in a horizontal scan direction, in the second image data.

By this configuration, with respect to a pixel area of two pixels×two pixels of the image, for example, in the video output using the YUV411 system in which a 4-byte brightness signal Y, a 1-byte chrominance signal U, a 1-byte chrominance signal V and a 2-byte dummy signal are output, the packing exponential part data can be configured by 2 bytes or less.

Accordingly, since the packing exponential part data can be multiplexed instead of 2-byte data (corresponding to the dummy signal) thinned when the chrominance signal U and the chrominance signal V are multiplexed with respect to the chrominance signal UV, it is possible to simply multiplex the exponential part data to the chrominance signal UV.

In the video output device according to a fourth aspect of the invention, the first image data is composed of the pixel data in which the value indicating each of the color elements of R, G and B configuring the pixel value is expressed by the floating point format in which the mantissa part has 8 bits, the cardinal number is 2 and the exponential part has 8 bits and the value indicated by the 8-bit exponential part has the same value in the color elements, and the exponential part converting unit converts the 8-bit exponential part corresponding to each of the color elements of the pixel data configuring the first image data into the 4-bit exponential part having the same value in the color elements.

By this configuration, with respect to a pixel area of two pixels×two pixels of the image, for example, in the video output using the YUV411 system in which a 4-byte brightness signal Y, a 1-byte chrominance signal U, a 1-byte chrominance signal V and a 2-byte dummy signal are output, the packing exponential part data can be configured by 2 bytes or less.

Accordingly, since the 2-byte packing exponential part data can be multiplexed instead of 2-byte data (corresponding to the dummy signal) thinned when the chrominance signal U and the chrominance signal V are multiplexed with respect to the chrominance signal UV, it is possible to simply multiplex the exponential part data to the chrominance signal UV.

In the video output device according to a fifth aspect of the invention, the multiplexing unit multiplexes the exponential part data to the chrominance signal UV corresponding to any one of an odd-numbered line or an even-numbered line of an image.

By this configuration, when the chrominance signal UV is output, in the signal output of a line (any one of an even-numbered line or an odd-numbered line) of the image for outputting the dummy signal, since the data signal of the exponential part can be output instead of the dummy signal, it is possible to simply multiplex and output the exponential part data without changing the configuration of the existing image data processing unit of the video output side using the YUV system.

According to a sixth aspect of the invention, there is provided a video output system including: a video output device; and a video processing device, wherein the video processing device generates display data for displaying an image in a predetermined display format on the basis of a video signal output from the video output device, wherein the video output device including: a mantissa part converting unit which, with respect to first image data composed of pixel data in which a pixel value is expressed by a floating point format in which a mantissa part has N bits (N is a natural number of 2 or more), a cardinal number is X (X is a natural number of 2 or more) and an exponential part has M bits (M is a natural number of 2 or more), converts mantissa part data of the pixel data configuring the first image data into a YUV system video signal including a brightness signal Y and a chrominance signal UV; a multiplexing unit which multiplexes exponential part data of the pixel data configuring the first image data to the chrominance signal UV of the YUV system video signal; and a video signal output unit which outputs the YUV system video signal including the brightness signal Y in the YUV system video signal obtained by conversion of the mantissa part converting unit and the chrominance signal UV obtained by multiplexing the exponential part data by the multiplexing unit, the video signal output unit separately outputs the brightness signal Y and the chrominance signal UV to the video processing device, wherein the video processing device including: a signal separating unit which separates the chrominance signal UV obtained by multiplexing the exponential part data received from the video output device into the chrominance signal UV of the mantissa part and the data signal of the exponential part; a format converting unit which converts the brightness signal Y received from the video output device and the chrominance signal UV obtained by separation into a signal of the data format of the mantissa part before conversion to the YUV system; and a display data generating unit which generates the display data on the basis of the data signal of the exponential part separated by the signal separating unit and the signal of the data format of the mantissa part obtained by conversion of the format converting unit.

By this configuration, in the video output device, with respect to image data composed of pixel data in which a pixel value is expressed by a floating point format in which a mantissa part has N bits (N is a natural number of 2 or more), a cardinal number is X (X is a natural number of 2 or more) and an exponential part has M bits (M is a natural number of 2 or more), mantissa part data of the pixel data configuring the image data can be converted into the YUV system video signal by the mantissa part converting unit, exponential part data of the pixel data configuring the image data can be multiplexed to the chrominance signal UV of the YUV system video signal by the multiplexing unit, and the YUV system video signal including the brightness signal Y and the chrominance signal UV obtained by multiplexing the exponential part data can be output by the video signal output unit.

In the video processing device, the chrominance signal UV received from the video output device can be separated into the chrominance signal UV of the mantissa part and the data signal of the exponential part by the signal separating unit, the brightness signal Y received from the video output device and the chrominance signal UV separated from the exponential part data can be converted into a signal of the data format of the mantissa part before conversion to the YUV system by the format converting unit, and the display data can be generated by the display data generating unit, on the basis of the data signal of the exponential part separated by the signal separating unit and the signal of the data format of the mantissa part obtained by conversion of the format converting unit.

Accordingly, since it is possible to output the video signal of the image data of the floating point format to the video processing device without changing the existing the YUV system interface and generate display data for displaying the image in the predetermined display format from the video signal output from the video output device, for example, it is possible to simply establish a display system for displaying an image of HDR image data of the floating point format or a monitoring system or a security system using the image of the HDR image data.

Here, the display data for displaying the image in the predetermined display format corresponds to HDR image data of a floating point format if an output device corresponds to the image data of the floating point format and corresponds to RGB image data of the floating point format, which is composed by converting the image data of the floating point format and has each pixel value expressed by an integer value, if the output device does not correspond to the image data of the floating point format. Hereinafter, the same is true in the aspect related to the video processing device and the video processing method.

In the video output device according to a seventh aspect of the invention, the mantissa part converting unit includes a separating unit which separates the second image data into plural pieces of data in the unit of data of a pixel area composed of j (j is a natural number of 2 or more) adjacent pixels and a converting unit which converts the mantissa part data of the pixel data corresponding to the j pixels of the pixel area into the YUV system video signal composed of one brightness signal Y for each pixel and the chrominance signal UV corresponding to k (k is a natural number of k<j) pixels for each pixel area, and the video processing device includes a chrominance signal interpolating unit which interpolates the chrominance signal UV corresponding to (j−k) pixels which are thinned for each pixel area, when the mantissa part data is converted into the YUV system video signal by the mantissa part converting unit.

By this configuration, the second image data can be converted into the video signal corresponding to various formats including a YUV411 format, a YUV211 format, and a YUV422 format.

Since the chrominance signal UV of the thinned pixel can be interpolated when the second image data is converted into the YUV system video signal, it is possible to generate display data with higher image quality.

According to an eighth aspect of the invention, there is provided a video processing device which converts mantissa part data of pixel data of image data composed of the pixel data, in which a pixel value is expressed by a floating point format, into a brightness signal Y and a chrominance signal UV and generates display data for displaying an image in a predetermined display format on the basis of a video signal composed by multiplexing exponential part data of the pixel data to the chrominance signal UV, the video processing device including: a signal separating unit which separates the chrominance signal UV obtained by multiplexing the exponential part data into the chrominance signal UV of the mantissa part and the data signal of the exponential part; a format converting unit which converts the brightness signal Y and the chrominance signal UV obtained by separation into a signal of the data format of the mantissa part before conversion to the YUV system; and a display data generating unit which generates the display data on the basis of the data signal of the exponential part separated by the signal separating unit and the signal of the data format of the mantissa part obtained by conversion of the format converting unit.

By this configuration, similar to the video processing device of the video processing system of the sixth aspect, since the display data for displaying the image in the predetermined display format can be generated from the YUV system video signal obtained by multiplexing the exponential part data, it is possible to simply establish the display system for displaying the image of the HDR image data of the floating point format.

According to a ninth aspect of the invention, there is provided a video output method of converting image data into a YUV system video signal composed of a brightness signal Y and a chrominance signal UV and outputting the video signal obtained by the conversion through a predetermined interface, the video output method including: with respect to first image data composed of pixel data in which a pixel value is expressed by a floating point format in which a mantissa part has N bits (N is a natural number of 2 or more), a cardinal number is X (X is a natural number of 2 or more) and an exponential part has M bits (M is a natural number of 2 or more), converting mantissa part data of the pixel data configuring the first image data into the YUV system video signal; multiplexing exponential part data of the pixel data configuring the first image data to the chrominance signal UV of the YUV system video signal; and outputting the YUV system video signal including the brightness signal Y and the chrominance signal UV obtained by multiplexing the exponential part data.

By this configuration, the same operation and effect as the video output device of the first aspect can be obtained.

According to a tenth aspect of the invention, there is provided a video processing method of converting mantissa part data of pixel data of image data composed of the pixel data, in which a pixel value is expressed by a floating point format, into a brightness signal Y and a chrominance signal UV and generating display data for displaying an image in a predetermined display format on the basis of a video signal composed by multiplexing exponential part data of the pixel data to the chrominance signal UV, the video processing method including: separating the chrominance signal UV obtained by multiplexing the exponential part data into the chrominance signal UV of the mantissa part and the data signal of the exponential part; converting the brightness signal Y and the chrominance signal UV obtained by separation into a signal of the data format of the mantissa part before conversion to the YUV system; and generating the display data on the basis of the data signal of the exponential part separated by the separating of the signal and the signal of the data format of the mantissa part obtained by the converting of the signal.

By this configuration, the same operation and effect as the video processing device of the eighth aspect can be obtained.

According to an eleventh aspect of the invention, there is provided a video output program which converts image data into a YUV system video signal composed of a brightness signal Y and a chrominance signal UV and outputs the video signal obtained by the conversion through a predetermined interface, the video output program including a program for executing a process on a computer, the process including: with respect to first image data composed of pixel data in which a pixel value is expressed by a floating point format in which a mantissa part has N bits (N is a natural number of 2 or more), a cardinal number is X (X is a natural number of 2 or more) and an exponential part has M bits (M is a natural number of 2 or more), converting mantissa part data of the pixel data configuring the first image data into the YUV system video signal; multiplexing exponential part data of the pixel data configuring the first image data to the chrominance signal UV of the YUV system video signal; and outputting the YUV system video signal including the brightness signal Y and the chrominance signal UV obtained by multiplexing the exponential part data.

By this configuration, when the program is read by the computer and the computer performs the process according to the read program, the same operation and effect as the video output device of the first aspect can be obtained.

According to a twelfth aspect of the invention, there is provided a video processing program which converts mantissa part data of pixel data of image data composed of the pixel data, in which a pixel value is expressed by a floating point format, into a brightness signal Y and a chrominance signal UV and generates display data for displaying an image in a predetermined display format on the basis of a video signal composed by multiplexing exponential part data of the pixel data to the chrominance signal UV, the video processing program including a program for executing a process on a computer, the process including: separating the chrominance signal UV obtained by multiplexing the exponential part data into the chrominance signal UV of the mantissa part and the data signal of the exponential part; converting the brightness signal Y and the chrominance signal UV obtained by separation into a signal of the data format of the mantissa part before conversion to the YUV system; and generating the display data on the basis of the data signal of the exponential part separated by the separating of the signal and the signal of the data format of the mantissa part obtained by the converting of the signal.

By this configuration, when the program is read by the computer and the computer performs the process according to the read program, the same operation and effect as the video processing device of the eighth aspect can be obtained.

### BRIEF DESCRIPTION OF THE DRAWINGS

The invention will be described with reference to the accompanying drawings, wherein like numbers reference like elements.

FIG. 1 is a block diagram showing the schematic configuration of a video processing system 1.

FIG. 2 is a block diagram showing the detailed configuration of a video output device 20.

FIG. 3 is a block diagram showing the detailed configuration of a video processing device 30.

FIG. 4 is a view showing an example of the configuration of HDR image data of an exponential part conversion format after conversion by an exponential part converting unit.

FIG. 5 is a view showing the output sequence of a Y signal.

FIG. 6 is a view showing a method of thinning a U signal and an output method.

FIG. 7 is a view showing a method of multiplexing and outputting a U signal and a V signal.

FIG. 8 is a view showing an example of the internal configuration of an UVEₚ multiplexing unit 203.

FIG. 9A is a view showing the configuration of an Eₚ signal and FIG. 9B is a view showing a method of multiplexing and outputting a UV signal and the Eₚ signal.

FIG. 10 is a view showing the configuration of a demultiplexer 304a included in an UVEₚ multiple signal separating unit 304.

FIG. 11 is a view showing the configuration of an UV signal separating circuit of the UVEₚ multiple signal separating unit 304.

FIG. 12 is a view showing the flow of an interpolation process of the UV signal.

FIGS. 13A and 13B are views showing the configuration of a known video processing system using a YUV system.

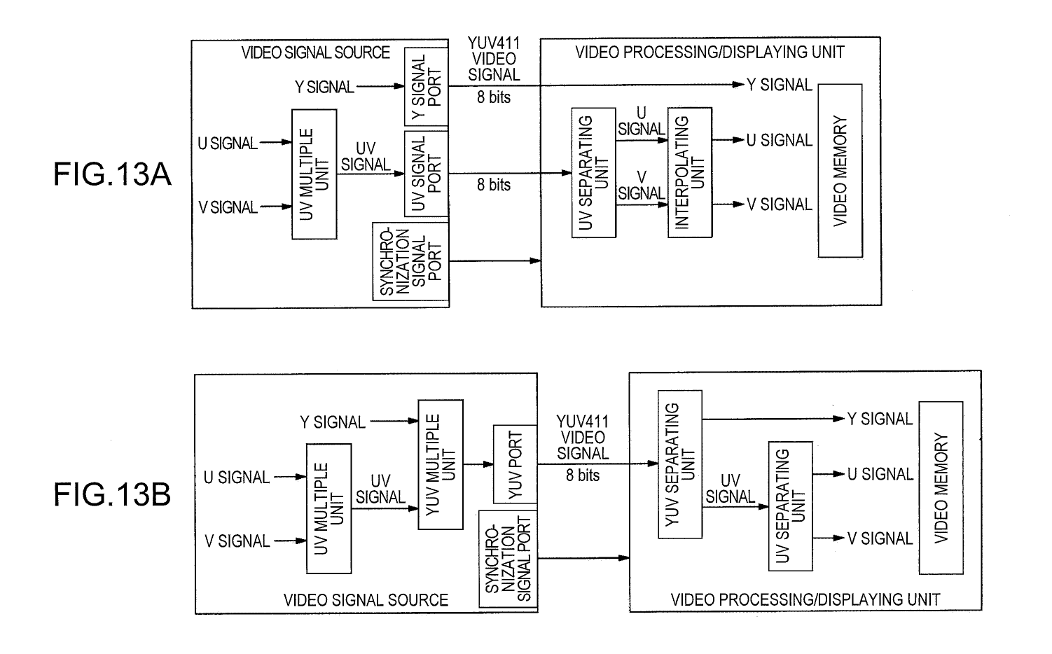

### DESCRIPTION OF EXEMPLARY EMBODIMENTS

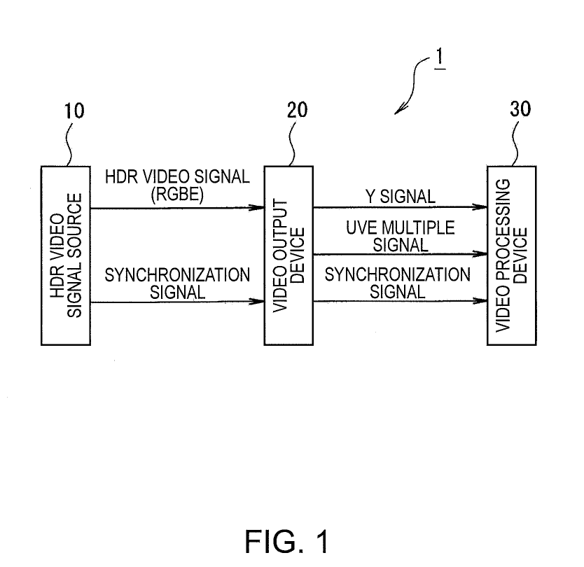

Hereinafter, a video output device, a video output method, a video processing system, a video processing device, and a video processing method according to the embodiment of the invention will be described with reference to the accompanying drawings. FIGS. 1 to 12 are views showing the video output device, the video output method, the video processing system, the video processing device, and the video processing method according to the embodiment of the invention. FIG. 1 is a block diagram showing the schematic configuration of a video processing system 1.

Hereinafter, the schematic configuration of the video processing system 1 will be described with reference to FIG. 1.

As shown in FIG. 1, the video processing system 1 includes a video output device 20 for converting a HDR image signal of a floating point format into a YUV system video signal on the basis of the HDR video signal and a synchronization signal from a HDR video signal source 10 and outputting the YUV system video signal to a video processing device 30, and the video processing device 30 for generating a HDR video signal on the basis of a brightness signal Y (hereinafter, referred to as a Y signal), an UVEₚ multiple signal obtained by multiplexing data of the exponential part with a chrominance signal UV and a synchronization signal from the video output device 20. The video output device 20 and the video processing device 30 are connected to each other through an interface (port) for inputting/outputting various types of signals.

Here, the HDR video signal source 10 is, for example, configured by an image pickup device for generating and outputting the HDR video signal from image pickup data picked up by an electronic camera and a storage medium for storing the HDR video data. In the present embodiment, the HDR video signal source 10 outputs the video signal (hereinafter, referred to as the HDR video signal) including information on RGBE image data (hereinafter, referred to as the HDR image data) of a Radiance format, which is composed of pixel data in which the value of each of color elements of RGB (red, green, blue) color spaces is expressed by the floating point format in which a mantissa part has N bits (N is a natural number of 8 or more), a cardinal number is 2 and an exponential part has M bits (M is a natural number of 8 or more).

In more detail, the HDR image data becomes the HDR image data of the floating point format in which each pixel data is composed of data of an N-bit mantissa part (Rᵢ[(N−1):0], Gᵢ[(N−1):0], Bᵢ[(N−1):0]) of each of the color elements R, G and B and data of an exponential part (E[(M−1):0]) common to every color element.

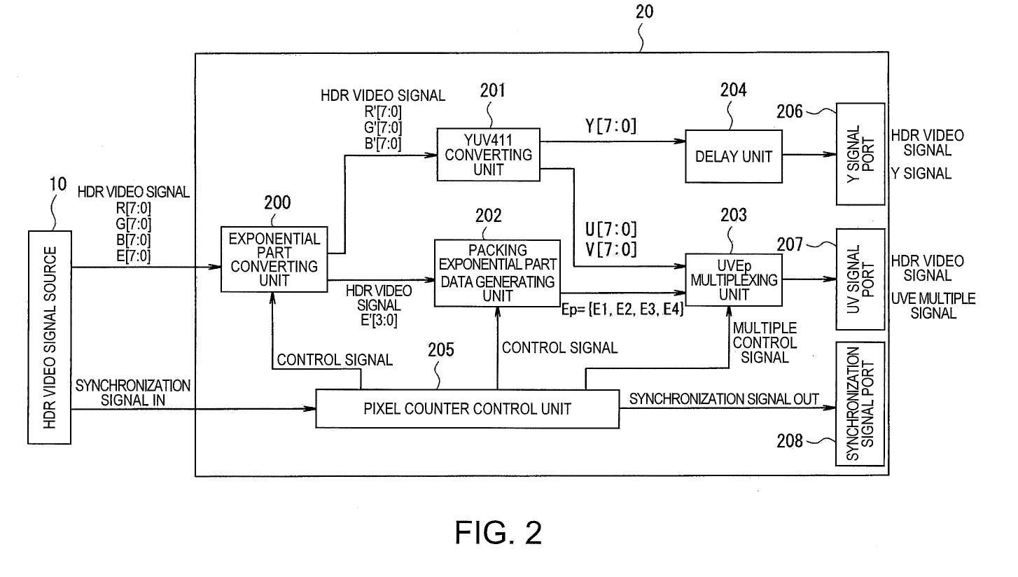

The detailed configuration of the video output device 20 will be described with reference to FIG. 2. FIG. 2 is a block diagram showing the detailed configuration of the video output device 20.

As shown in FIG. 2, the video output device 20 includes an exponential part converting unit 200, a YUV411 converting unit 201, a packing exponential part data generating unit 202, an UVEₚ multiplexing unit 203, a delay unit 204, a pixel counter control unit 205, a Y signal port 206, a UV signal port 207 and a synchronization signal port 208.

The exponential part converting unit 200 changes the bit number of the exponential part of the HDR image data configuring the data according to a YUV411 output format, on the basis of the data indicated by the HDR video signal of the floating point format from the HDR video signal source 10.

In more detail, if the bit number of the exponential part of the pixel data of the HDR image data is 5 bits or more, the value of the mantissa part is changed such that the exponential part can be expressed by 4 bits or less, and the bit number of the exponential part is changed to 4 bits.

In the HDR image data after conversion (hereinafter, referred to as HDR image data of an exponential part conversion format), each pixel data is composed of data of an N-bit mantissa part (R′ᵢ[(N−1):0], G′ᵢ[(N−1):0], B′ᵢ[(N−1):0]) of each color element and data of an exponential part (E′[(M−1):0]) common to every color.

The exponential part converting unit 200 outputs the data of the mantissa part of each pixel data of the HDR image data of the exponential part conversion format to the YUV411 converting unit 201 and outputs the data of the exponential part to the packing exponential part data generating unit 202.

The YUV411 converting unit 201 receives the data of the mantissa part after conversion from the exponential part converting unit 200 and converts it into a video signal of a YUV411 output format.

In the YUV411 output format, as described above, every pixel is output with respect to the brightness signal, that is, the Y signal, and the amount of information is reduced in consideration of low spatial frequency for color of the eyes of a human with respect to the chrominance signal, that is, the U signal and the V signal. In more detail, with respect to the U signal and the V signal, one representative value is obtained from four pixels and only the representative value is output. For example, if the mantissa part is 8-bit image data, a 1-byte U signal and a 1-byte V signal are output with respect to a 4-byte Y signal.

Accordingly, the YUV411 converting unit 201 converts the data (R′ᵢ[(N−1):0], G′ᵢ[(N−1):0], B′ᵢ[(N−1):0]) of the mantissa part of each pixel data of the HDR image data of the exponential part conversion format into YUV411 data (Y[(N−1):0], U[(N−1):0], V[(N−1):0]).

The YUV411 converting unit 201 outputs Y[(N−1):0] to the delay unit 204 and outputs U[(N−1):0] and V[(N−1):0] to the UVEₚ multiplexing unit 203, in the data of the mantissa part after conversion.

The packing exponential part data generating unit 202 receives the data (E′[m (m is a natural number of 4 or less):0]) of the exponential part after conversion from the exponential part converting unit 200 and generates packing exponential part data (Eₚ={E_{n(n=1, 2, 3 . . . )}, Eₙ₊₁, Eₙ₊₂, Eₙ₊₃}) composed of the data of the exponential part of four pixels, for every successive four pixels in a horizontal scan direction. In more detail, since the bit number of the exponential part of each pixel is changed to 4 bits or less in the exponential part converting unit 200, the packing exponential part data becomes data having 4 bits×4=16 bits (2 byte) at a maximum.

The YUV411 converting unit 201 outputs the generated packing exponential part data to the UVEₚ multiplexing unit 203.

The UVEₚ multiplexing unit 203 receives a data signal (hereinafter, referred to as a packing exponential part data signal) of the packing exponential part data from the packing exponential part data generating unit 202, receives the U signal and the V signal from the YUV411 converting unit 201, multiplexes the UV signal and the packing exponential part data signal on the basis of a multiple control signal received from the pixel counter control unit 205, and outputs the multiplexed signal to the UV signal port 207.

In more detail, since the U signal and the V signal are reduced by the amount of information of ¼ as described above, instead of the output of dummy data generated at an output timing of any one of an odd-numbered line or an even-numbered line, the packing exponential part data signal is output. If the U signal and the V signal are output at the output timing of the odd-numbered line, the packing exponential part data signal (hereinafter, referred to as an Eₚ signal) is output at the output timing of the even-numbered line.

The delay unit 204 is a buffer for synchronization of the Y signal, the UV signal and the Eₚ signal. In more detail, the delay amount generated by the packing exponential part data generating unit 202 and the UVEₚ multiplexing unit 203 is corrected by delaying the Y signal.

The pixel counter control unit 205 counts the line number and the pixel number of the HDR image data on the basis of a synchronization signal IN from the HDR video signal source 10. On the basis on the counted result, a control signal for controlling the exponential part converting unit 200 and the packing exponential part data generating unit 202 is generated and a multiple control signal for controlling the UVEₚ multiplexing unit 203 is generated. The generated control signals are input to the respective components. For synchronization of the Y signal, the UV signal and the Eₚ signal after delay, a synchronization signal OUT obtained by delaying the synchronization signal IN is generated and is output to the synchronization signal port 208.

The Y signal port 206 has an 8-bit data output width (bus width) and outputs the Y signal received through the delay unit 204 to the video processing device 30.

The UV signal port 207 has an 8-bit data output width (bus width) and outputs the multiplexed UV signal and Eₚ signal (hereinafter, referred to as an UVEₚ multiple signal) received from the UVEₚ multiplexing unit 203 to the video processing device 30.

The synchronization signal port 208 outputs the synchronization signal OUT received from the pixel counter control unit 205 to the video processing device 30.

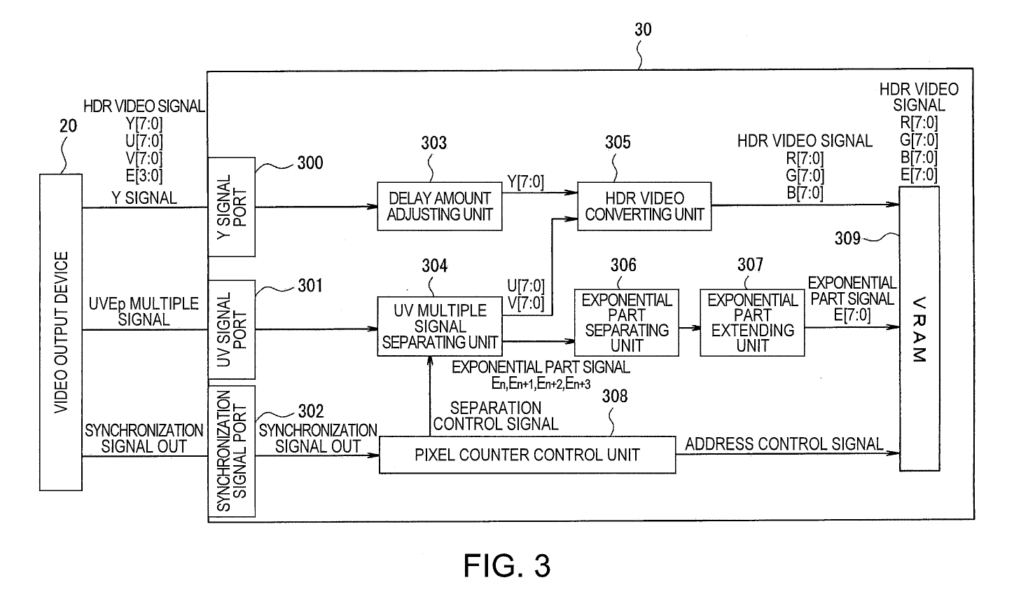

The detailed configuration of the video processing device 30 will be described with reference to FIG. 3. FIG. 3 is a block diagram showing the detailed configuration of the video processing device 30.

The video processing device 30 includes a Y signal port 300, an UV signal port 301, a synchronization signal port 302, a delay amount adjusting unit 303, an UVEₚ multiple signal separating unit 304, a HDR video converting unit 305, an exponential part separating unit 306, an exponential part extending unit 307, a pixel counter control unit 308, and a video random access memory (VRAM) 309.

The Y signal port 300 has an 8-bit data output width (bus width) and outputs the Y signal received from the video output device 20 to the delay amount adjusting unit 303.

The UV signal port 301 has an 8-bit data output width (bus width) and outputs the UVEₚ multiple signal received from the video output device 20 to the UVEₚ multiple signal separating unit 304.

The synchronization signal port 302 outputs the synchronization signal OUT received from the video output device 20 to the pixel counter control unit 308.

The delay amount adjusting unit 303 is a buffer for synchronization of the Y signal and the UVEₚ multiple signal. In more detail, the delay amount generated by the UVEₚ multiple signal separating unit 304 is corrected by delaying the Y signal.

The UVEₚ multiple signal separating unit 304 separating the UVEₚ multiple signal into the UV signal and the Eₚ signal and performs the synchronization of the UV signal, the Eₚ signal and the synchronization signal OUT.

The UVEₚ multiple signal separating unit 304 outputs the separated UV signal to the HDR video converting unit 305 and outputs the separated Eₚ signal to the exponential part separating unit 306.

The HDR video converting unit 305 performs an interpolation process with respect to the UV signal, generates the UV signal of the lacking pixel part, and separates the U signal and the V signal, on the basis of the Y signal received from the delay amount adjusting unit 303 and the UV signal received from the UVEₚ multiple signal separating unit 304. Next, on the basis of the Y signal and the U signal and V signal after interpolation, the Y signal, the U signal and the V signal are converted into (returned to) the RGB signal.

The HDR video converting unit 305 outputs RGB data after conversion (R′ᵢ[(N−1):0], G′ᵢ[(N−1):0], B′ᵢ[(N−1):0]) to the VRAM 309.

The exponential part separating unit 306 separates the packing exponential part data (Eₚ[4:0]), which is obtained by combining four pixels to one, to four pieces of data on the basis of the Eₚ signal received from the UVEₚ multiple signal separating unit 304 and outputs the separated exponential part data to the exponential part extending unit 307.

The exponential part extending unit 307 extends 4-bit exponential part data to 8 bits (0 is inserted into four high significant bits) and outputs the 8-bit exponential part data after expansion to the VRAM 309.

The pixel counter control unit 308 counts the synchronization signal OUT received from the synchronization signal port 302, outputs an address control signal for applying the address (XY coordinate) of the pixel, and outputs the address control signal to the VRAM 309.

The VRAM 309 stores the RGB data received from the HDR video converting unit 305 and the exponential part data received from the exponential part expansion unit 307 in correspondence with each other, on the basis of the address control signal from the pixel counter control unit 308.

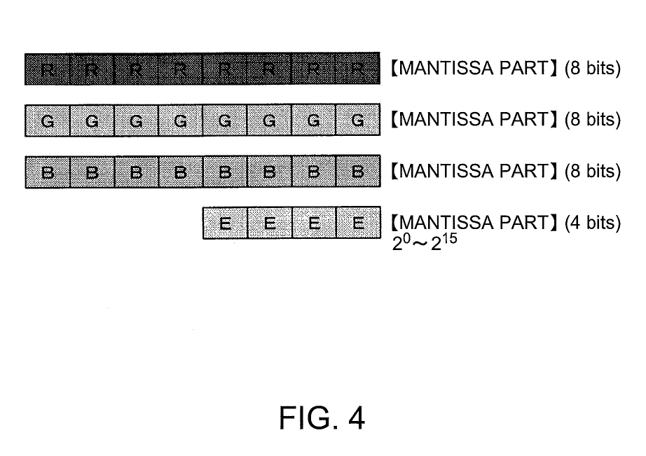

Next, the operation of the video processing system 1 having the above-described configuration will be described with reference to FIGS. 4 to 12.

First, the operation of the video output device 20 will be described with reference to FIGS. 4 to 9.

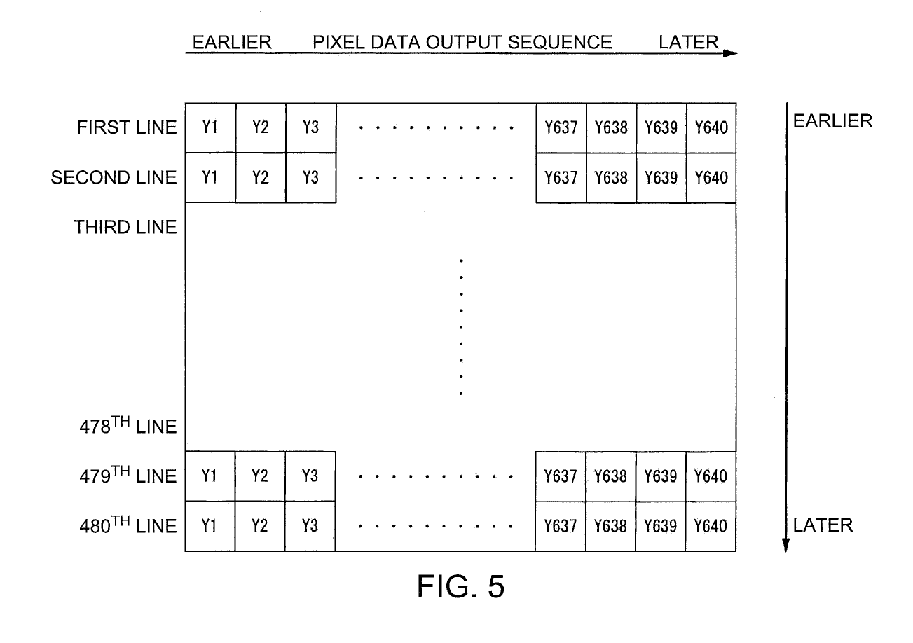

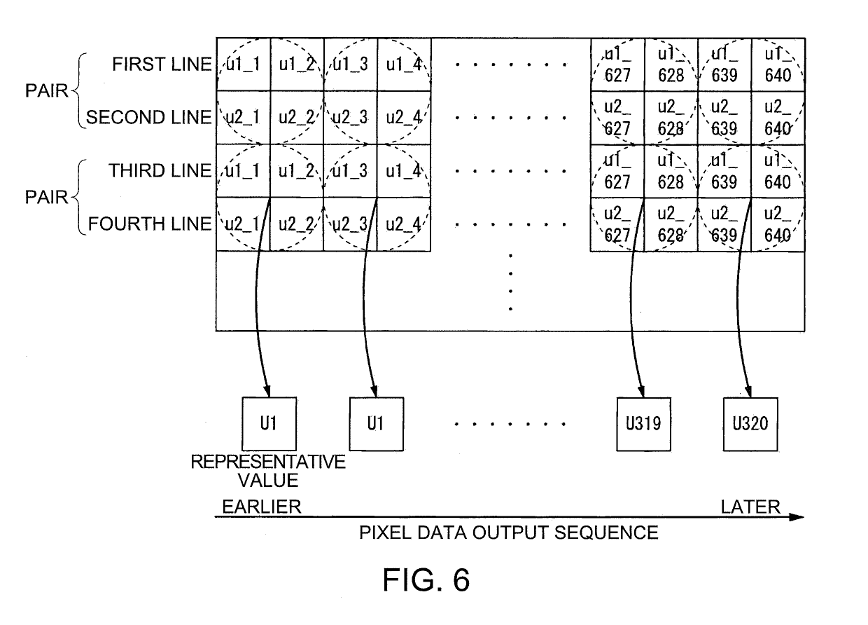

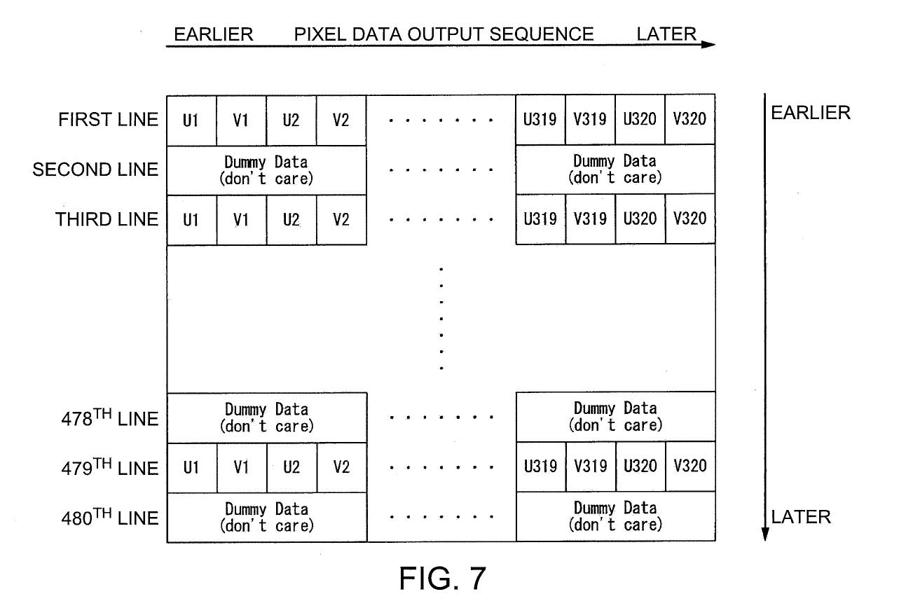

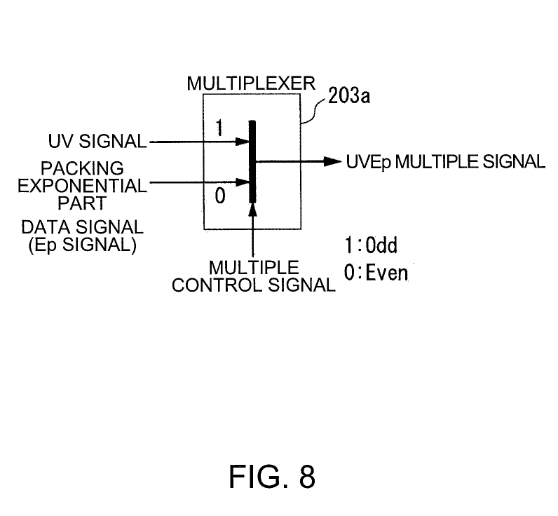

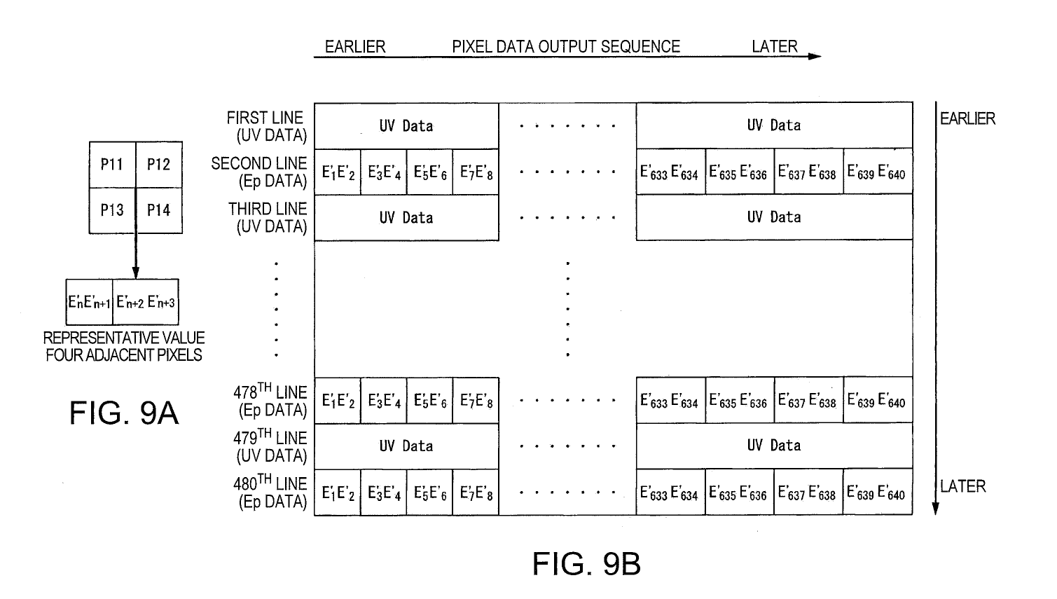

FIG. 4 is a view showing an example of the configuration of HDR image data of an exponential part conversion format after conversion by the exponential part converting unit. FIG. 5 is a view showing the output sequence of the Y signal. FIG. 6 is a view showing a method of thinning the U signal and an output method. FIG. 7 is a view showing a method of multiplexing and outputting the U signal and the V signal. FIG. 8 is a view showing an example of the internal configuration of the UVEₚ multiplexing unit 203. FIG. 9A is a view showing the configuration of the Eₚ signal and FIG. 9B is a view showing a method of multiplexing and outputting the UV signal and the Eₚ signal.

The HDR video signal source 10 outputs the synchronization signal IN and the HDR video signal of the Radiance format composed of pixel data, in which a mantissa part has 8 bits, a cardinal number is 2 and an exponential part has 8 bits with respect to each color of the RGB signal, to the video output device 20.

The HDR video signal output from the HDR video signal source 10 is input to the exponential part converting unit 200 of the video output device 20 and the synchronization signal IN is input to the pixel counter control unit 205 of the video output device 20.

The video output device 20 receives the synchronization signal IN from the pixel counter control unit 205, counts the number of pulses of the synchronization signal IN, generates the control signal for controlling the operations of the exponential part converting unit 200 and the packing exponential part data generating unit 202 and the multiple control signal for controlling the operation of the UVEₚ multiplexing unit 203, and outputs the control signals to the respective components.

The exponential part converting unit 200 converts the 8-bit exponential part into the 4-bit exponential part in the received HDR video signal and, as shown in FIG. 4, generates the HDR image data (R′ᵢ[7:0], G′ᵢ[7:0], B′ᵢ[7:0], E′[3:0]) of the exponential part conversion format having the pixel data in which the value indicating each of the color elements of RGB is expressed by an 8-bit mantissa part and a 4-bit exponential part common to the color elements, on the basis of the control signal received from the pixel counter control unit 205.

The exponential part converting unit 200 outputs the mantissa part data (R′ᵢ[7:0], G′ᵢ[7:0], B′ᵢ[7:0]) in the generated HDR image data of the exponential part conversion format to the YUV411 converting unit 201 and outputs the exponential part data (E′[3:0]) to the packing exponential part data generating unit 202.

The YUV411 converting unit 201 receives and converts the mantissa part data into the YUV411 format and outputs the converted data.

Hereinafter, the HDR image data in which the number of pixels in the horizontal scan direction (hereinafter, referred to as a horizontal direction) is 640 and the number of pixels in a vertical scan direction (hereinafter, referred to as a vertical direction) is 480 will be, for example, described.

First, the YUV411 converting unit 201 converts the pixel data R′ᵢ, G′ᵢ, B′ᵢ into the pixel data of the brightness information Y, a difference U between the brightness and a red component and a difference V between the brightness of a blue component. This converting method is known and thus will be omitted.

Next, the pixel data (Y[7:0]) of the Y signal of the pixel data converted into the YUV is, as shown in FIG. 5, sequentially output from the data of the pixel data Y1 located at the left end of a first line. After the data of the pixel Y640 located at the right end of the line, the data of the pixel Y1 located at the left end of a second line is output. As described above, the pixel data of the Y signal is sequentially output to the delay unit 204 from the pixel data which is first received from the exponential part converting unit 200 with respect to all pixels.

As shown in FIG. 6, the YUV411 converting unit 201 obtains one representative value (for example, u1) from four pieces of pixel data (for example, u11, u12, u21 and u22) for every four pieces of pixel data of two pixels in the horizontal direction×two pixels in the vertical direction, with respect to the U signal and the V signal. Only the obtained representative value is output to the UVEₚ multiplexing unit 203. Similarly, even with respect to the V signal, only the representative value obtained from four pixels is output to the UVEₚ multiplexing unit 203. Accordingly, the U signal and the V signal output from the YUV411 converting unit 201 to the UVEₚ multiplexing unit 203 becomes ¼ of the total data amount of the Y signal.

Meanwhile, the packing exponential part data generating unit 202 receives the exponential part data (E′[3:0]) of the HDR image data of the exponential part conversion format and generates the packing exponential part data (Eₚ={E′ₙ, E′ₙ₊₁, E′ₙ₊₂, E′ₙ₊₃}) composed of E′ [3:0] of four pixels for every successive four pixels in the horizontal direction, on the basis of the control signal received from the pixel counter control unit 205. Here, n is the pixel number of each line of the image and, if the number of pixels in the horizontal direction 640, n becomes a value in a range of 1 to 637. Accordingly, the packing exponential part data becomes Eₚ₁={E′₁, E′₂, E′₃, E′₄}, Eₚ₂={E′₅, E′₆, E′₇, E′₈}, . . . , Eₚ₁₅₉={E′₆₃₃, E′₆₃₄, E′₆₃₅, E′₆₃₆}, Eₚ₁₆₀={E′₆₃₇, E′₆₃₈, E′₆₃₉, E′₆₄₀} for every line.

The signal of the generated packing exponential part data (hereinafter, referred to as the Eₚ signal) is sequentially output to the UVEₚ multiplexing unit 203.

The UVEₚ multiplexing unit 203 receives the U signal, the V signal and the Eₚ signal, multiplexes the U signal, the V signal and the Eₚ signal on the basis of the multiple control signal received from the pixel counter control unit 205, and outputs the multiplexed UVEₚ multiple signal to the UV signal port 207.

Here, in the YUV411 system, in the outputs of the U signal and the V signal, as described above, since only one representative value is output with respect to the four pixels, the U signal and the V signal are output by one pixel in a time period when the Y signal is output by four pixels. For example, in the past, as shown in FIG. 7, the U signal and the V signal are alternately output (multiple output) at an output timing of an odd-numbered line and dummy data is output at an output timing of an even-numbered line. The dummy data may be output in the output period of the odd-numbered line and the U signal and the V signal may be output in the output period of the even-numbered line.

That is, in the known YUV411 system, the U signal and the V signal are multiplexed and output in the output period of the odd-numbered line and the UV signal data corresponding to two lines of the Y signal is output in the output period of one line. Since only the UV signal of one line, that is, the odd-numbered line, is output with respect to the two lines of the Y signal, in the known system, the dummy data was output in the output period of the even-numbered line, for synchronization with the Y signal.

In contrast, the video output device 20 according to the present embodiment, the Eₚ signal which is the data signal of the exponential part is output in a time period when the dummy data is output (in the above example, the output period of the even-numbered line, in which the dummy data is output). Accordingly, the Eₚ signal and the UV signal are multiplexed.

In more detail, as shown in FIG. 8, the UVEₚ multiplexing unit 203 has a multiplexer 203a. The multiplexer 203a switches the output signal to any one of the UV signal and the Eₚ signal and multiplexes the UV signal to the Eₚ signal, on the basis of the multiple control signal from the pixel counter control unit 205.

The pixel counter control unit 205 outputs the multiple control signal indicating “1” when the count of the pixel is the odd-numbered line and outputs the multiple control signal indicating “0” when the count of the pixel is the even-numbered line.

Accordingly, when the Eₚ signal and the UV signal are input, the multiplexer 203a outputs the UV signal in a time period when the multiple control signal “1” is received and outputs the Eₚ signal in a time period when the multiple control signal “0” is received.

Accordingly, as shown in FIG. 9B, the Eₚ signal composed of the data shown in FIG. 9A is output to the UV signal port 207 in the output period of the even-numbered output period and the UV signal is output to the UV signal port 207 in the output period of the odd-numbered line.

Subscripts of E′₁E′₂, E′₃E′₄ of FIG. 9B represent pixel numbers. For example, E′₁ becomes the exponential part data of a pixel having a pixel number of 1.

The delay unit 204 delays the Y signal by the delay amount generated by the packing exponential part data generating unit 202 and the UVEₚ multiplexing unit 203 and outputs the Y signal to the Y signal port 206 in synchronization with the UV signal or the Eₚ signal.

The Y signal output to the Y signal port 206 is output from the Y signal port 206 to the video processing device 30. The UVEₚ multiple signal output to the UV signal port 207 is output from the UV signal port 207 to the video processing device 30.

The outputs of the Y signal and the UVEₚ multiple signal according to the present embodiment are performed at a frame rate of 30 fps. In more detail, it is performed on the basis of the synchronization signal (synchronization signal OUT) generated by delaying the synchronization signal IN received from the HDR video signal source 10.

Here, the synchronization signal OUT is three signals including a vertical synchronization signal indicating the start of the frame of the output video data, a horizontal synchronization signal indicating the start of the line and a pixel synchronization signal or a complex signal of the three signals.

In the above-described sequence, the HDR video signal of the floating point format from the HDR video signal source 10 is converted into the YUV system format and the exponential part data is multiplexed to the UV signal and is output to the video processing device 30 together with the Y signal.

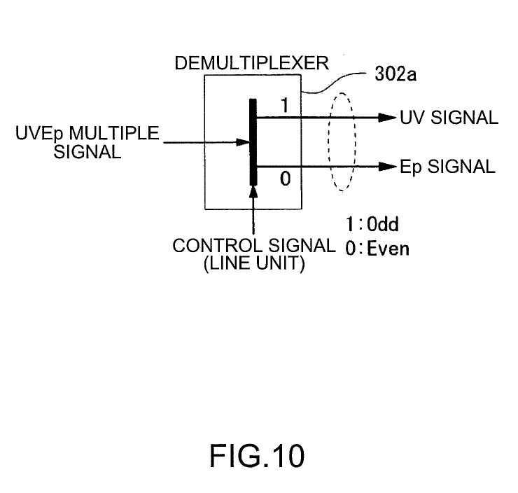

Next, the operation of the video processing device 30 will be described with reference to FIGS. 10 to 12.

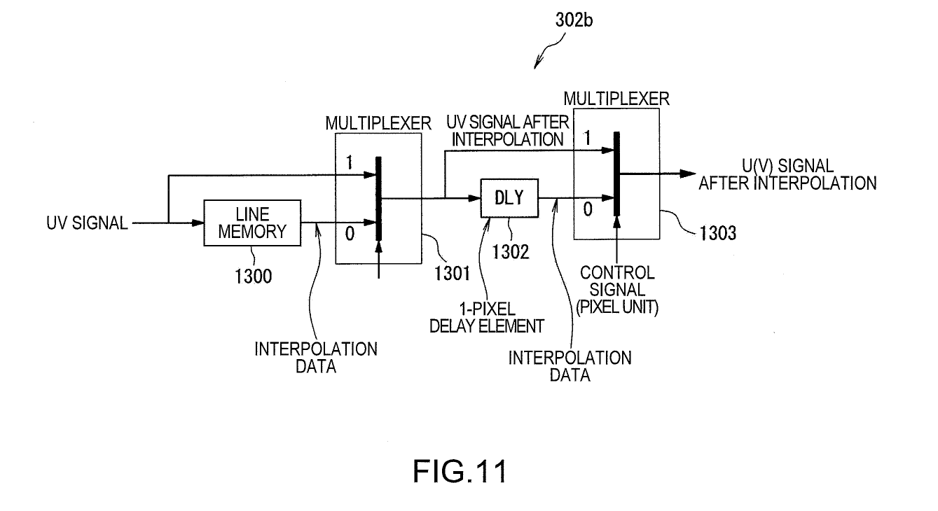

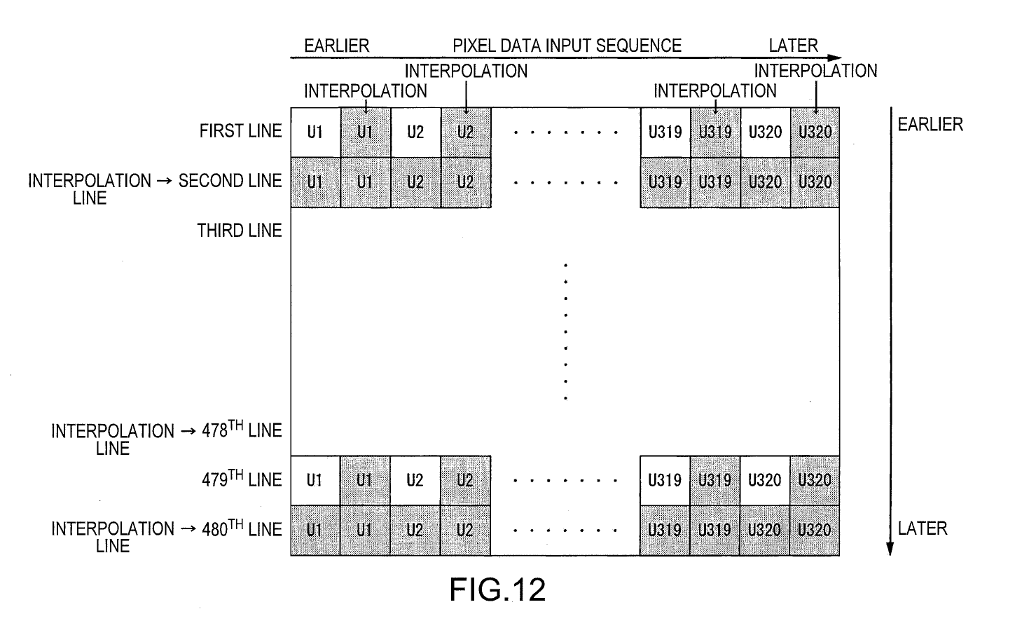

FIG. 10 is a view showing the configuration of a demultiplexer 302a included in the UVEₚ multiple signal separating unit 304. FIG. 11 is a view showing the configuration of an UV signal separating circuit of the UVEₚ multiple signal separating unit 304. FIG. 12 is a view showing the flow of an interpolation process of the UV signal.

In the video processing device 30, among the signals output from the video output device 20, the Y signal is input to the delay amount adjusting unit 303 through the Y signal port 300. The UVEₚ multiple signal is input to the UVEₚ multiple signal separating unit 304 and the synchronization signal OUT is input to the pixel counter control unit 308.

The pixel counter control unit 308 generates the address control signal for applying the address (XY coordinate) of the pixel on the basis of the received synchronization signal OUT and outputs the address control signal to the VRAM 309. On the basis of the received synchronization signal OUT, a separation control signal for switching “0” and “1” according to the line number is generated and is output to the UVEₚ multiple signal separating unit 304.

The UVEₚ multiple signal separating unit 304 has the demultiplexer 302a shown in FIG. 10. The demultiplexer 302a separates the UVEₚ multiple signal into the UV signal and the Eₚ signal. In more detail, the multiplexed UV signal and Eₚ signal are separately output on the basis of the separation control signal switched for each of the above-described line numbers received from the pixel counter control unit 308 such that the UV signal and the Eₚ signal are separated.

The UVEₚ multiple signal separating unit 304 has the UV signal separating circuit 302b shown in FIG. 11. The UV signal separating circuit 302b interpolates the data of three remaining pixels removed by selecting one representative value from the four pixels in the UV signal separated by the demultiplexer 302a, separates the multiplexed UV signal into the U signal and the V signal, and outputs the U signal and the V signal after interpolation to the HDR video converting unit 305.

As shown in FIG. 11, the UV signal separating circuit 302b includes a line memory 1300 for storing the received UV signal by one line, a multiplexer 1301, a delay element 1302 and a multiplexer 1303. The UV signal is input to the multiplexer 1303 through the line memory 1300 or directly. When the UV signal corresponding to the odd-numbered line is received, the UV signal separating circuit 302b outputs and stores this signal in the line memory 1300. In contrast, when the UV signal corresponding to the even-numbered line is received, the odd-numbered signal stored in the line memory 1300 is output. As a result, the UV signal corresponding to the odd-numbered line is always output from the multiplexer 1301.

When the odd-numbered (pixel unit) pixel data is received, the UV signal separating circuit 302b outputs the pixel data to the HDR video converting unit 305 and delays the pixel data by the delay element 1302. When the even-numbered (pixel unit) pixel data is received, the pixel data delayed by the delay element 1302 is output to the HDR video converting unit 305. As a result, the U signal is separated from the V signal and is output to the HDR video converting unit 305. The output pixel data becomes a pixel array shown in FIG. 12. In FIG. 12, the pixel data which is delayed and output by the line memory 1300 and the delay element 1302 is interpolation pixel data which is represented by a gray color. By the above-described operation, the V signal is separated from the U signal and is output to the HDR video converting unit 305.

The Eₚ signal which is separated from the UV signal by the demultiplexer 302a is output to the exponential part separating unit 306.

The delay amount adjusting unit 303 delays the Y signal received through the Y signal port 300 by a processing time of the UVEₚ multiple signal separating unit 304 and synchronizes the output timing of the Y signal with that of the UV signal.

The HDR video converting unit 305 converts the U signal and the V signal received from the UVEₚ multiple signal separating unit 304 and the Y signal, which is delayed by the delay amount adjusting unit 303 and is received in synchronization with the U signal and the V signal, into the HDR video signal (mantissa part) of RGB. The HDR video signal (R′ᵢ[7:0], G′ᵢ[7:0], B′ᵢ[7:0]) after conversion is output to the VRAM 309.

The exponential part separating unit 306 receives the Eₚ signal from the UVEₚ multiple signal separating unit 304 and separates the exponential part data (E′ₙ, E′ₙ₊₁, E′ₙ₊₂, E′ₙ₊₃) of four pixels included in Eₚ signal into the data of each pixel. The separated exponential part data (E[3:0]) of each pixel is output to the exponential part extending unit 307.

The exponential part extending unit 307 extends the 4-bit exponential part data of each pixel separated by the exponential part separating unit 306 to the 8-bit exponential part data (E′[7:0]) and outputs the 8-bit exponential part data to the VRAM 309. The expansion of the exponential part is performed by setting the received 4-bit exponential part data to four low significant bits and inserting “0” as four high significant bits.

The VRAM 309 operates on the basis of the address control signal received from the pixel counter control unit 308 and stores the mantissa part data (R′ᵢ[7:0], G′ᵢ[7:0], B′ᵢ[7:0]) of the HDR video signal received from the HDR video converting unit 305 and the exponential part data (E[7:0]) received the exponential part extending unit 307 in correspondence with each other. Accordingly, the HDR image data composed of the pixel data in which the value of each color element is expressed by the floating point format of the mantissa part (R′ᵢ[7:0], G′ᵢ[7:0], B′ᵢ[7:0]) and the exponential part (E′[7:0]) is configured on the memory of the VRAM 309.

The video processing device 30 may, if necessary, process the HDR image data of the floating point format stored in the VRAM 309 and generate display data for displaying the image in another format. For example, the HDR image data of the floating point format is converted into the HDR image data of the fixed point format.

According to the video processing system 1 of the present embodiment, when the HDR video signal of the floating point format obtained by the HDR video signal source such as the electronic camera is converted into the YUV411 video signal by the video output device 20 and is output to the video output device 30, the exponential part data is multiplexed to the UV signal and thus can be output using the existing UV signal port. Accordingly, since the exponential part data can be output without changing the YUV system output interface, it is possible to configure a system for outputting the HDR video signal of a floating point format to the video processing device 30 without increasing cost.

Since the video output device 20 generates the packing exponential part data obtained by combining the exponential part data of four pixels and multiplexes the packing exponential part data to the UV signal, it is possible to output the packing exponential part data in the output period of the dummy data at the outputting the UV signal, by the YUV411 system. Accordingly, it is possible to easily multiplex the exponential part data to the UV signal and output the UV signal.

In the video output device 30, the UVEₚ multiple signal obtained by multiplexing the packing exponential part data to the UV signal can be separated into the UV signal and the Eₚ signal and the Eₚ signal can be separated into the exponential part data of each pixel. The Y signal and the UV signal can be converted into the RGB signal and the mantissa part data of the HDR image data can be generated (restored) and stored in the VRAM 309. The separated exponential part data can extend and the exponential part data of the HDR image data can be generated (restored) and stored in the VRAM 309. Accordingly, the HDR image data of the floating point format can be formed on the memory of the VRAM 309.

In the video processing device 30, since the YUV411 video signal output from the video output device 20 can be converted into the HDR image data of the original format and stored in the VRAM 309, a video system such as a security system or a crime prevention system using a monitoring cameral can be simply configured using the present system 1.

In the embodiment, the exponential part converting unit 200 corresponds to an exponential part converting unit of any one of second to fourth aspects, the YUV411 converting unit 201 corresponds to a mantissa part converting unit of any one of first, second, third, sixth and seventh aspects or a mantissa part converting step of a ninth or eleventh aspect, the UVEₚ multiplexing unit 203 corresponds to a multiplexing unit of any one of the first, second, fifth and sixth aspects or a multiplexing step of the ninth or eleventh aspect, and the packing exponential part data generating unit 202 corresponds to the packing exponential part data generating unit of the second or third aspect.

In the embodiment, a process of separating the UV signal and the Eₚ signal in the UVEₚ multiple signal separating unit 304 corresponds to a signal separating unit of the sixth or eighth aspect or a signal separating step of the tenth or twelfth aspect, a process of interpolating the lacking data of the UV signal in the UVEₚ multiple signal separating unit 304 corresponds to a chrominance signal interpolating unit of the seventh aspect, the HDR video converting unit 305 corresponds to a format converting unit of the sixth or eighth aspect or a format converting step of the tenth or twelfth aspect, and a process of storing the mantissa part data after conversion by the HDR video converting unit 305 and the exponential part data separated and extended by the exponential part separating unit 306 and the exponential part extending unit 307 in the VRAM 309 and forming the HDR image data of the floating point format on the memory corresponds to a display data generating unit of the sixth or eighth aspect or a display data generating step of the tenth or twelfth aspect.

Although, in the embodiment, the video output device 20 and the video processing device 30 are used as the main components of hardware, the invention is not limited thereto and various processing functions such as a converting process, a multiplexing process and a separating process may be used main components of software. In this case, the video output device 20 and the video processing device 30 includes a computer system which includes a processor for executing a program, a ROM for storing the program for realizing the processes, a RAM for storing an execution program or various types of data necessary for executing the program and a bus for transmitting/receiving data between the components.

Although, in the embodiment, the HDR image data output from the HDR video signal source 10 includes the 8-bit mantissa part, the cardinal of 2, and the 8-bit exponential part, the invention is not limited thereto. The mantissa part may have 7 bits or less or 9 bits or more, the cardinal part may be a value other than 2, and the exponential part may have 3 bits or less or 5 bits or more.

Although, in the embodiment, the invention applies to the YUV411 system which is one of the YUV system, the invention is not limited thereto. The invention may apply to other YUV systems including a YUV211 system, a YUV422 system and a YUV444 system.

The entire disclosure of Japanese Patent Application Nos. 2007-038919, filed Feb. 20, 2007 and 2007-333903, filed Dec. 26, 2007 are expressly incorporated by reference herein.

What is claimed is:

1. A video output device which converts image data into a YUV system video signal composed of a brightness signal Y and a chrominance signal UV and outputs the video signal obtained by the conversion through a predetermined interface, the video output device comprising:
a mantissa part converting unit which, with respect to first image data composed of pixel data in which a pixel value is expressed by a floating point format in which a mantissa part has N bits (N is a natural number of 2 or more), a cardinal number is X (X is a natural number of 2 or more) and an exponential part has M bits (M is a natural number of 2 or more), converts mantissa part data of the pixel data configuring the first image data into the YUV system video signal;
a multiplexing unit which multiplexes exponential part data of the pixel data configuring the first image data to the chrominance signal UV of the YUV system video signal; and
a video signal output unit which outputs the YUV system video signal including the brightness signal Y and the chrominance signal UV obtained by multiplexing the exponential part data.

2. The video output device according to claim 1, further comprising:
an exponential part converting unit which converts the M-bit exponential part of the pixel data configuring the first image data into an m-bit (m is a natural number of M>m) exponential part; and
a packing exponential part data generating unit which generates packing exponential part data configured by the exponential part data in the pixel data of a predetermined number of pixels for each pixel data of the predetermined number of successive pixels in a predetermined scan direction, in second image data which is image data after converting the exponential part by the exponential part converting unit,
wherein the mantissa part converting unit converts the mantissa part data of the pixel data configuring the second image data into the YUV system video signal, and
wherein the multiplexing unit multiplexes the packing exponential part data to the chrominance signal UV of the YUV system video signal.

3. The video output device according to claim 2, wherein:
the first image data is color image data of a RGB (red, green and blue) format, the value of each of the color elements of R, G and B configuring the pixel value is expressed by the floating point format in which the mantissa part has the N bits, the cardinal number is 2 and the exponential part has the M bits, and the value expressed by the M-bit exponential part is composed of pixel data having the same value in the color elements,
the exponential part converting unit converts the M-bit exponential part corresponding to the color elements of the pixel data configuring the first image data into 4-bit or less exponential part having the same value in the color elements,
the mantissa part converting unit converts the mantissa part data corresponding to the color elements of the pixel data configuring the second image data into a YUV411 system video signal which is one of the YUV system, and
the packing exponential part data generating unit generates the packing exponential part data composed of the exponential part data in the pixel data of four pixels for each pixel data of successive four pixels in a horizontal scan direction, in the second image data.

4. The video output device according to claim 3, wherein the first image data is composed of the pixel data in which the value indicating each of the color elements of R, G and B configuring the pixel value is expressed by the floating point format in which the mantissa part has 8 bits, the cardinal number is 2 and the exponential part has 8 bits and the value indicated by the 8-bit exponential part has the same value in the color elements, and
the exponential part converting unit converts the 8-bit exponential part corresponding to each of the color elements of the pixel data configuring the first image data into the 4-bit exponential part having the same value in the color elements.

5. The video output device according to claim 1, wherein the multiplexing unit multiplexes the exponential part data to the chrominance signal UV corresponding to any one of an odd-numbered line or an even-numbered line of an image.

6. A video output system comprising:
a video output device; and
a video processing device,
wherein the video processing device generates display data for displaying an image in a predetermined display format on the basis of a video signal output from the video output device,
wherein the video output device comprising:
a mantissa part converting unit which, with respect to first image data composed of pixel data in which a pixel value is expressed by a floating point format in which a mantissa part has N bits (N is a natural number of 2 or more), a cardinal number is X (X is a natural number of 2 or more) and an exponential part has M bits (M is a natural number of 2 or more), converts mantissa part data of the pixel data configuring the first image data into a YUV system video signal including a brightness signal Y and a chrominance signal UV;
a multiplexing unit which multiplexes exponential part data of the pixel data configuring the first image data to the chrominance signal UV of the YUV system video signal; and
a video signal output unit which outputs the YUV system video signal including the brightness signal Y in the YUV system video signal obtained by conversion of the mantissa part converting unit and the chrominance signal UV obtained by multiplexing the exponential part data by the multiplexing unit,
the video signal output unit separately outputs the brightness signal Y and the chrominance signal UV to the video processing device,
wherein the video processing device comprising:
a signal separating unit which separates the chrominance signal UV obtained by multiplexing the exponential part data received from the video output device into the chrominance signal UV of the mantissa part and the data signal of the exponential part;
a format converting unit which converts the brightness signal Y received from the video output device and the chrominance signal UV obtained by separation into a signal of the data format of the mantissa part before conversion to the YUV system; and
a display data generating unit which generates the display data on the basis of the data signal of the exponential part separated by the signal separating unit and the signal of the data format of the mantissa part obtained by conversion of the format converting unit.

7. The video processing system according to claim 6, wherein:
the mantissa part converting unit includes a separating unit which separates the second image data into plural pieces of data in the unit of data of a pixel area composed of j (j is a natural number of 2 or more) adjacent pixels and a converting unit which converts the mantissa part data of the pixel data corresponding to the j pixels of the pixel area into the YUV system video signal composed of one brightness signal Y for each pixel and the chrominance signal UV corresponding to k (k is a natural number of k<j) pixels for each pixel area, and
the video processing device includes a chrominance signal interpolating unit which interpolates the chrominance signal UV corresponding to (j−k) pixels which are thinned for each pixel area, when the mantissa part data is converted into the YUV system video signal by the mantissa part converting unit.
